(19) United States
(12) Patent Application Publication
(10) Pub. No.: US 2014/0072797 A1
(43) Pub. Date: Mar. 13, 2014

(54) COATING COMPOSITIONS AND METHODS FOR MITIGATING ICE BUILD-UP

(71) Applicants: Scott Moravek, Cranberry Township, PA (US); Mark P. Bowman, New Kensington, PA (US); Davina Schwartzmiller, Allison Park, PA (US); Jane N. Valenta, Pittsburgh, PA (US); Edward Rakiewicz, Gibsonia, PA (US); Gordon L. Post, Pittsburgh, PA (US)

(72) Inventors: Scott Moravek, Cranberry Township, PA (US); Mark P. Bowman, New Kensington, PA (US); Davina Schwartzmiller, Allison Park, PA (US); Jane N. Valenta, Pittsburgh, PA (US); Edward Rakiewicz, Gibsonia, PA (US); Gordon L. Post, Pittsburgh, PA (US)

(73) Assignee: PPG Industries Ohio, Inc., Cleveland, OH (US)

(21) Appl. No.: 13/612,927

(22) Filed: Sep. 13, 2012

(51) Int. Cl. B32B 9/04; B05D 5/06; F03D 11/00; B32B 5/02; B32B 27/08

(52) U.S. Cl. 428/328; 428/702; 428/339; 416/223 R; 427/160

(57) ABSTRACT

Multilayer coating systems for mitigating ice build-up on a substrate, methods of applying and related substrates are disclosed. The coating system may comprise a first coating, and a second coating deposited on at least a portion of the first coating, wherein the first coating and/or second coating comprises a near-IR absorber. Methods of applying a multilayer coating composition to a substrate may comprise applying a first coating, and applying a second coating over at least a portion of the first coating, wherein the first coating and/or second coating comprises a near-IR absorber.

### FIELD OF THE INVENTION

The present disclosure is directed to ice mitigation coating systems containing near-IR absorber and methods of mitigating ice build-up on substrates, particularly suitable for use on wind turbine blades and aircraft parts such as wings and propeller blades.

### BACKGROUND INFORMATION

Coating formulations and their application over various substrates find use in numerous industries, such as, for example, those employing coated coil, coated electronic displays, coated wind blades, gutters and coated automotive components.

Many parts of the world experience winter conditions during which outdoor equipment, utility poles, power lines, gutters and the like can be exposed to snow, freezing rain and/or sleet. Under such weather conditions, the equipment can become covered with ice, thus impairing the normal operation thereof. For example, wind turbine blades are constantly exposed to the elements and must be designed to endure temperature extremes, wind shears, precipitation, and other environmental hazards without failure. Build-up of ice on the blade substrate leads to lower efficiencies as the blades become heavier and harder to turn. Currently blades are sometimes deiced with electric heaters, which have multiple disadvantages.

Accordingly, the need exists to provide a coating that could be applied to protect the equipment and method of mitigating ice build-up on such equipment. It would be further desirable to protect wind turbine blades and maximize the efficiency of the blades in extreme weather. It would also be desirable to provide such protection while achieving or maintaining the desired appearance and color of the coated object.

### SUMMARY OF THE INVENTION

The present invention is directed to a multilayer coating system that comprises a first coating, and a second coating deposited on a least a portion of the first coating, wherein the first coating and/or second coating comprises a near-infrared absorber.

The present invention is further directed to a method of applying a multilayer coating composition to a substrate comprising (a) applying a first coating, and (b) applying a second coating over at least a portion of the first coating, wherein the first coating and/or second coating comprises a near-infrared absorber. The invention is further directed to substrates coated by such methods and/or with such multilayer coating systems.

It should be understood that this invention is not limited to the embodiments disclosed in this summary, and it is intended to cover modifications that are within the spirit and scope of the invention, as defined by the claims.

### DETAILED DESCRIPTION OF THE INVENTION

The present invention is directed to a multilayer coating system that comprises a first coating, and a second coating deposited on a least a portion of the first coating wherein the first coating and/or second coating comprises a near-infrared absorber. As used herein “near-IR absorber” means a near-IR absorbing pigment which is an effective absorber of near-infrared radiation of wavelengths from 760 nanometers to 3.3 microns. Suitable near-IR absorbers include organic and inorganic materials, for example, antimony tin oxide, titanium nitride, organic quaterrylenes, carbon black, tungsten oxide, reduced tungsten oxides, tungstates, and tungsten bronzes. In embodiments, one or more near-IR absorbers can be used.

The near-IR absorber may be solid or liquid and it can be dissolved in an aqueous or organic solvent, a dry powder, or a powder dispersed in an aqueous or organic solvent. If the near-IR absorber is a solid, it may be any suitable size such as a micron sized powder or, optionally, a nanosized powder. In examples the near-IR absorber is milled from a micron sized powder to a nanosized powder. Micron sized near-IR absorber powders can be commercially sourced. In embodiments, the near-IR absorber has an average particle size ranging from 10 nm to 15 micron. In other embodiments the near-IR absorber has an average particle size ranging from 50 nm to 1,000 nm. In yet other embodiments the near-IR absorber has an average particle size ranging from 50 nm to 150 nm, or can be much smaller. In particularly suitable embodiments the near-IR absorber has an average particle size of 150 nm. In other suitable embodiments the near-IR absorber has an average particle size of 110 nm.

It will be appreciated that the near-IR absorber can be included in the first or second coating by any means known in the art. In embodiments, the near-IR absorber can be added with or without the presence of a dispersing agent. IR embodiments, other components such as flow or leveling agents may be present in the coating. Those skilled in the art will appreciate there are many components that can be used in coatings, some of which (such as flow or leveling agents) can act as dispersing agents. In embodiments, the near-IR absorber is admixed with a dispersing agent or milled in the presence of a dispersant. Nanoparticle dispersions can also be produced by crystallization, precipitation, gas phase condensation, and chemical attrition (i.e., partial dissolution). Milling the near-IR absorber in the presence of a dispersant can minimize and/or protect the nanoparticles from re-agglomerating. As a result, a relatively stable dispersion can be created. In embodiments the dispersion is stable such that the particles can remain in storage for months at ambient temperate. In embodiments, the dispersant is added to prevent agglomeration in the can, to increase its shelf life. Any suitable dispersant known in the art can be used. In embodiments a polymeric dispersing agent can be used including, for example, Solsperse 32500 (Lubrizol, Wickliffe, Ohio).

In general, the near-IR absorber can be present in the first or second coating composition in any amount sufficient to impart a desired increase in substrate temperature. In embodiments, a sufficient amount of near-IR absorber includes an amount of near-IR absorber needed to absorb an increased amount of near-IR radiation to increase the temperature of the substrate when the coated substrate is exposed to a near-IR source, such as sunlight. The amount of near-IR absorber used in the first or second coating can vary depending upon a number of factors including, for example, the coating thickness, the affect desired, the loading and/or weight of the near-IR absorber and which near-IR absorber or absorbers are used in a particular application.

Additionally, there is a balance between the benefit (increased substrate temperature) and the cost (absorber expense and color impact from use of near-IR absorber in a second coating, such as a topcoat). For example, a thinner second coating or topcoat can require the addition of less near-IR absorber in the first coating than would otherwise be needed to effectively raise the substrate temperature if a relatively thicker film thickness were used. For example, a standard topcoat film build could require the addition of more near-IR absorber in the first coating and, optionally, also in the second coating. In an example, a film build for a polyurethane primer (such as HSP-7401 wind turbine blade polyurethane primer, PPG Industries, Inc.) of 2.5 mils or for a polyurethane topcoat (such as AUE-57035 gray wind blade coating, PPG Industries, Inc.) of 2.5 mils could block near-IR from reaching the first coating. In such examples it may be desired to decrease the film thickness of the second coating and/or add or increase the amount of near-IR absorber added in the second coating. In embodiments, the amount of near-IR absorber used in the first coating may be decreased or removed if the second coating also contains near-IR absorber, as described below.

In embodiments, the near-IR absorber is included in the first and/or second coating in an amount of at least about 10 ppm by weight, or more particularly 500 ppm by weight, in the dried film. In such examples, the near-IR absorber can include a reduced tungsten oxide dispersion. In embodiments, the near-IR absorber may comprise from 0.01 to 15 weight percent by weight of the first coating, with weight percent based on the total solid weight of the coating. In embodiments the near-IR absorber may comprise from 0.1% and 10% of the total weight of the coating. Higher levels of near-IR absorber would possibly increase the de-icing effect. Additionally, the deicing effect may be further increased by use of near-IR absorber in the first and second coating, such as a primer layer and the topcoat.

Any suitable coating can be used as the first and/or second coating. For example, the first coating can comprise any of a variety of thermoplastic and/or thermosetting compositions known in the art. Thermosetting or curable coating compositions typically comprise film-forming polymers or resins having functional groups that are reactive with either themselves or a crosslinking agent. Thermoplastic coating compositions typically comprise similar film-forming polymers or resins that set by drying, such as solvent evaporation, rather than chemical reaction. For both thermoplastic and/or thermosetting compositions the film-forming polymer or resin can comprise for example, acrylic polymers, polyester polymers, polyurethane polymers, polyamide polymers, polyether polymers, polysiloxane polymers, polyepoxy polymers, epoxy resins, vinyl resins, copolymers thereof, and mixtures thereof. Generally, these polymers can be any polymers of these types made by any method known to those skilled in the art. Such polymers may be solvent-borne or water-dispersible, emulsifiable, or of limited water solubility. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof. Appropriate mixtures of film-forming polymers or resins may also be used in the preparation of one or both of the present coating compositions. For example, the coating compositions can comprise any of a variety of thermoplastic and/or thermosetting compositions known in the art.

Thermosetting coating compositions often, but in many cases do not, comprise a crosslinking agent that may be selected from any of the crosslinkers known in the art to react with the functionality used in the film-forming polymer or resin in the coating. Suitable examples include multifunctional isocyanates, epoxides, amines and acrylic polyols. In certain embodiments, where more than one thermosetting film-forming polymer or resin is used in a coating, the crosslinker in one of the thermosetting film-forming polymers or resins is either the same or different from the crosslinker that is used to crosslink the one or more other thermosetting film-forming polymers or resins. In certain other embodiments, a thermosetting film-forming polymer or resin having functional groups that are reactive with themselves is used; in this manner, such thermosetting coatings are self-crosslinking.

If desired, the coating compositions can comprise other optional materials well known in the art of formulating coatings, such as colorants, plasticizers, abrasion-resistant particles, anti-oxidants, hindered amine light stabilizers, UV light absorbers and stabilizers, surfactants, flow control agents, thixotropic agents, tillers, organic cosolvents, reactive diluents, catalysts, grind vehicles, and other customary auxiliaries.

As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent- and/or aqueous-based such as acid dyes, azoic dyes, basic dyes, direct dyes, disperse dyes, reactive dyes, solvent dyes, sulfur dyes, mordant dyes, for example, bismuth vanadate, anthraquinone, perylene aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water-miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemicals, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 800 nm, such as less than 200 nm, or less than 70 nm. Nanoparticles can be produced by milling stock organic or inorganic pigments with grinding media having a particle size of less than 5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application Ser. No. 60/482,167 filed. Jun. 24, 2003, and U.S. patent application Ser. No. 11/337,062, filed Jan. 20, 2006, which is also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The first and second coating can comprise any of a variety of suitable thermoplastic and/or thermosetting compositions known in the art as described as above. In embodiments the first and second coatings comprise thermoplastic compositions. In a specific embodiment, the first coating comprises a coating primer and the second coating comprises a white topcoat. In another specific embodiment, the first coating comprises an epoxy primer and the second coating comprises a polyester topcoat. For example, commercial white coil coating primer, such as 1PLW5852 available from PPG Industries, Inc., can be used for the first coating, and Truform® white coil topcoat (available from PPG Industries, Inc.) can be used for the second coating. In another example, the first coating comprises a commercial wind blade primer, such as HSP-7401 available from PPG Industries, Inc. and the second coating comprises a commercial wind blade topcoat, such as AUE-57035 available from PPG Industries, Inc.

In embodiments the second coating comprises a film-fanning polymer or resin or mixtures thereof that comprise the same or different film-forming polymer or resin or mixtures thereof that are used in first coating. In embodiments, the first coating comprises a film-forming polymer or resin comprising near-IR absorber and the second coating comprises a film-forming polymer or resin to which no near-IR absorber is added. In certain embodiments, the second coating comprises a film-forming polymer or resin and near-IR absorber. In certain suitable embodiments, the second coating comprises near-IR absorber, and a film-forming polymer or resin that is different from the film-forming polymer or resin in the first coating. In embodiments the near-IR absorber is present in the second coating in an amount that is less than the amount of near-IR absorber used in the first coating. In still other embodiments, the second coating comprises a film-fanning polymer or resin to which near-IR absorber is added and the first coating comprises a film-forming polymer or resin to which no near-IR absorber is added.

In embodiments the near-IR absorber is present in the second coating in an amount of 0.01 to 50 percent by weight. In embodiments, the second coating contains 0.1 to 10 percent by weight near-IR absorber of the total amount of near-IR absorber present in the first coating. In an example, the coating composition has same amount of near-IR absorber in the first coating (such as a primer) as in the second coating (such as a topcoat) (0.6% weight in each). The near-IR absorber can also be used in the topcoat formula at a level of 0.6% over primer which did not contain NIR absorber. Use of near-IR absorber in the second layer such as a topcoat yielded an improved deicing effect but also altered the color of the coated system. Such color change is unacceptable for certain applications, such as wind blade applications. While various examples of allocating near-IR absorber between the first coating and second coating show benefit, the amount of near-IR absorber used in one coating need not be tied to that amount which is used in the other coating. It can be the same amount, greater amount or lesser amount than in the other coating.

The first and second coatings of the present invention can be used alone, or in combination with one or more other coatings. For example, the first coating can be used as a primer, basecoat, or other underlayer. A “basecoat” is typically pigmented; that is, it will impart some sort of color and/or other visual effect to the substrate to which it is applied. An underlayer includes anything other than the topcoat or last coating layer. The second coating can be another underlayer or a topcoat. In embodiments the second coating provides protection to an underlayer such as, for example, the first coating. In embodiments the second coating can be selected thr one or more reasons that those skilled in the art would appreciate such as, for example, to achieve the desired final color and/or appearance or protection. In instances where the second coating is an underlayer, a topcoat or clearcoat may also be used over all or a portion of the second coating. In examples, the second coating and/or any topcoat or clearcoat has near-IR transparency characteristics sufficient for the transmission of near-IR light if the first coating or an underlayer is the only layer containing near-IR absorber. In embodiments when the near-IR absorber is incorporated only in the first coating, the second coating or topcoat is either transparent or of thin enough film to allow the transmission of near-IR radiation.

A clearcoat will be understood as a coating that is substantially transparent. A clearcoat can therefore have some degree of color, provided it does not make the clearcoat opaque or otherwise affect, to any significant degree, the ability to see the underlying substrate. The clearcoats used according to the present invention can be used, for example, in conjunction with a pigmented underlayer, such as a pigmented second coating. In certain embodiments, the substantially clear coating composition can comprise a colorant but not in an amount such as to render the clear coating composition opaque (not substantially transparent) after it has been cured.

The present multilayer coating system can be applied to any of a variety of substrates, for example, carbon fiber and/or fiberglass composite substrates such as blades of wind turbines. These substrates can be, for example, metallic or non-metallic. Metallic substrates include tin, steel, tin-plated steel, chromium passivated steel, galvanized steel, aluminum, aluminum foil, coiled steel or other coiled metal. Non-metallic substrates including polymeric, plastic, polyester, polyolefin, polyamide, cellulosic, polystyrene, polyacrylic, polyethylene naphthalate), polypropylene, polyethylene, nylon. EVOH, polylactic acid, other “green” polymeric substrates, poly(ethyleneterphthalate) (“PET”), polycarbonate, polycarbonate acrylobutadiene styrene (“PC/ABS”), polyamide, epoxy, composites of glass and/or carbon fiber with polymer, wood, veneer, wood composite, particle board, medium density fiberboard, cement, stone, glass, paper, cardboard, textiles, leather, both synthetic and natural, and the like. The substrate can be one that has been already treated in some manner, such as to impart visual and/or color effect.

The coatings of the present invention can be applied or deposited to all or a portion of any such suitable substrate in any manner known to those of ordinary skill in the art. For example, the coatings of the present invention can be applied by electrocoating, spraying, electrostatic spraying, dipping, rolling, brushing, roller coating, flow coating, extrusion, coil coating of flat sheet stock techniques and the like. As used herein, the phrase “deposited on” or “deposited over” or “applied” to a substrate, and like terms, means deposited or provided above or over but not necessarily adjacent to the surface of the substrate. For example, a coating can be deposited directly upon the substrate or one or more other coatings can be applied there between. A layer of coating can be typically formed when a coating that is deposited onto a substrate or one or more other coatings is substantially cured or dried.

In certain embodiments of the present invention, a film of the first coating comprising a near-IR absorber is deposited onto all or a portion of a substrate. The first coating can be applied to any film thickness appropriate for the situation. In embodiments the first coating can be applied such that the dry film thickness is about 0.1 to about 40 mils, or, more particularly, 0.2 to 10 mils. In embodiments, the first coating can be cured or dried or both by any means in the art. For examples, a thermosetting coating may be cured by UV, and a thermoplastic coating may be dried by air. In other embodiments, the first coating is not cured or dried, but rather remains wet or essentially wet when a second coating is applied.

The term “cure”, “cured,” “curing” or similar terms, as used in connection with a cured or curable coating or composition, e.g., a “cured composition” or “cured dry film” of some specific description, “a thermosetting composition”, or “a thermoplastic composition” means that at least a portion of the polymerizable and/or crosslinkable components that form the cured composition is polymerized and/or cross linked. Additionally, curing of a polymerizable thermosetting composition refers to subjecting the composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive end groups occurs, rate of reaction of the remaining unreacted reactive end groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate.

In thermoplastic compositions, the term “cure” as used herein refers to a drying and/or fusing process, typically by heating the coated substrate to a temperature and for a time sufficient to substantially remove any solvents and/or fuse the polymer. In examples, the coated substrate can be air dried at ambient temperature. For example, the term “cure” should be understood to include the drying and/or fusing of thermoplastic coatings such as fluorocarbon coil coatings or certain latex coatings. In an example, a thermoplastic coating or composition is cured after solvent has evaporated and/or components have fused in an amount sufficient for at least a portion of the components to form or harden resulting in a suitable coating without appreciable change of properties.

In embodiments for use with thermoplastic and/or thermosetting compositions, the coatings of the present invention are cured at ambient temperature. Curing occurs for an amount of time sufficient to enable the coatings to be substantially dried. For examples, the first coating can be cured for a period of 15 minutes to overnight. The second coating can be cured for a period of time ranging from 20 minutes to 7 days, depending upon the characteristics of the coating composition. In embodiments, the second coating can be cured for a period of time ranging from 1 hour to 2 days.

The second coating may be applied to all or a portion of the first coating using any of the methods described above. In embodiments, the second coating can be applied to any film thickness appropriate or desired for the situation. In embodiments the second coating can be applied such that the dry film thickness is about 0.1 to about 40 mils, or, more particularly, (12 to 10 mils. The functional thickness range of the second coating can vary depending upon the coating system. The second coating is then cured at ambient temperature, or optionally by applying heat or near-IR radiation.

In embodiments, the second coating is deposited on a first coating that has been cured and/or dried. In some embodiments, after forming a film of the first coating on the substrate, a second coating is deposited directly on the first coating, in a wet-on-wet process. In embodiments the wet-on-wet process can eliminate the need to wait for the first coating to cure before applying the second coating thereby offering potential time savings.

When the coating system is exposed to a near-IR source such as sunlight, the first and/or second coating, doped with the near-IR absorber, absorbs an increased amount of near-IR radiation, converts the energy to heat thereby causing the coating to heat up. As a result, the first and/or second coating containing near-IR absorber can get hot faster when exposed to a near-IR source than without the absorber. In turn the heat from the first and/or second coating increases the temperature of the coated substrate and can provide further benefit to applications in which having an elevated surface temperature may be desired. In examples, the thickness of the film build of the second coating or topcoat is selected to allow the near-IR wavelengths to pass through it to the first coating or primer which contains the near-IR absorber. The near-IR absorber then converts the energy (light) to heat thereby causing the coating to heat up. If the film thickness of the second coating is too great the near-IR wavelengths of light can be filtered out before reaching the first coating or primer layer.

For example, elevated surface temperature may be desired for surfaces which are exposed to cold and/or icy conditions. In examples, the present invention can be used with wind blades to enhance solar deicing of the wind blade. Usually wind blades are painted with an off-white color, which can be more prone to icing problems than would be the case if they were painted black. Heating up the second coating though use of a near-IR absorber in the first coating (and optionally also in the second coating) can elevate the temperature of the wind blade thus causing the ice to melt faster on the wind blade. Further, use of the near-IR absorber in the first coating can eliminate or minimize a color change in the topcoat, as further discussed below. In embodiments this invention could be used in combination with other ice mitigation coatings, such as those designed for enhanced ice mitigation with low ice adhesion.

In certain suitable embodiments, the present invention is useful for lighter colored coatings. Use of a near-IR absorber in an underlayer, such as the first coating, can help to increase the amount of near-IR absorbed by the lighter colored coating thus enabling it to capture more of the near-IR that could have otherwise been blocked and/or reflected resulting in an increased substrate temperature. Additionally, conventional near-IR additives can impact the visible light absorption, and therefore can affect the color of the coating. Lighter color coatings can be especially sensitive to the color imparted by near-IR absorbers (for example, some near-IR absorbers impart a blue hue), such as when used in the topcoat. Inclusion of the near-IR absorber in an underlayer of a coating system can eliminate or minimize potential color shifts that could otherwise result from adding near-IR absorber in the coating system, such as in the second coating or topcoat. A color shifts or change is determined by comparing the color of a coating system containing no near-IR absorber with the coating system containing near-IR absorber. If the comparison shows no perceptible change in color between the two systems no color shift is detected. For example this shift can be measured using spectroscopy. The range of tolerable color change varies depending upon the application. For some applications for which color change is a concern, the color change has a delta E that is not greater than 10. In other applications, the delta E is not greater than 5 or, more particularly, it is not greater than 2 or 1. In embodiments, less or no near-IR absorber can be added to the second coating or topcoat while still enabling the coating system to attain higher substrate temperatures than without near-IR absorber in the first coating or primer.

In certain embodiments, the coating system of the present invention is particularly suitable for use on carbon fiber and/or fiberglass composite substrates, such as a wind blades or utility poles.

Before depositing coatings on the surface of the substrate, it is typically desired to prepare the surface to be coated, for example, by sanding or scuffing. The substrate can be lightly scuffed with an abrasive material, such as Scotch-Brite pads (3M). Thereafter the substrate can be cleaned, for example, by wiping with a cleaning solvent, such as DX-330 (PPG Industries, Inc.), to remove residual sanding dust and contaminants.

Accordingly, the present invention is also directed to a carbon fiber and/or fiberglass substrate coated at least in part with the coating system described above.

The multilayer coating systems of the present disclosure can increase the temperature of a substrate which may be useful to melt or mitigate the build-up of ice, snow, freezing rain and/or sleet on the substrate while maintaining the desired appearance of the coated substrate.

For purposes of the above detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent. For example, although reference is made herein to “a” first coating composition layer, “a” topcoat, “a” dispersing agent and the like, one or more of each of these components, and of any other components, can be used.

The various embodiments and examples of the present invention as presented herein are each understood to be non-limiting with respect to the scope of the invention.

The invention will be further described by reference to the following examples. The following examples are merely illustrative of the invention and are not intended to be limiting.

### EXAMPLES

Examples were conducted to demonstrate the effects of using a near-IR absorber in a multilayer coating system and methods for preparation thereof. In each of these Examples 1-4 below, a thermocouple from Omega Engineering (Part No. SA1-K-SRJC) was placed on a substrate and subsequently coated with one of various coating systems described herein. First, each substrate was coated with a primer and allowed to cure at room temperature tier two hours. After cure, a topcoat was applied to the primed substrate, allowed to cure at room temperature for seven days, and then placed under a near-IR light and measured for temperature panels. In Examples 1-4, the near-IR lamp was placed about 18 inches from the panel surface. The panel surface temperatures were measured using a microprocessor digital thermometer model #819, from Tegam Inc.

Reduced Tungsten Oxide Dispersion

A near-IR absorber was formulated as follows: 240 grams of reduced tungsten oxide (WO_{2.72} GTP Corp., Towanda, Pa.) and 360 grams of Solsperse 32500 (Lubrizol, Wickliffe, Ohio) were ground in an Eiger mill at 3500 rpm for one hour with 2.0 mm beads, followed by grinding for eight hours with 0.3 mm beads. This yielded a reduced tungsten oxide dispersion with an average particle size of 110 nm. This reduced tungsten oxide dispersion near-IR absorber was added to each of the coatings as described in the examples below.

### Example 1

### Control Wind Blade Coating System

A first coating of HSP-7401 (a commercially available wind blade primer from PPG Industries, Inc.) was spray applied to a fiberglass composite substrate with an Omega thermocouple attached to the surface. The primer was allowed to dry at room temperature for two hours. Then a second coating of AUE-57035 (a commercially available wind blade topcoat from PPG Industries, Inc.) was spray applied over the first coating and allowed to cure at room temperature for seven days before testing.

### Example 2

### Wind Blade Coating System Utilizing 0.6% Reduced Tungsten Oxide by Weight in the Primer Layer

A first coating was prepared by mixing 1.34 g of reduced tungsten oxide, described in prior example, with 168 g of HSP-7401. This mixture was catalyzed with 32 g of AUE-3550 (available from PPG Industries, Inc.), and reduced to spray viscosity with the addition of 40 g of n-butyl acetate. This coating was then spray applied to a fiberglass composite substrate with an Omega thermocouple attached to the surface. The sample was allowed to dry at room temperature for two hours. The sample was then overcoated with AUE-57035, spray applied, and allowed to cure at room temperature for seven days before testing.

### Example 3

### Coating System Utilizing 0.6% Reduced Tungsten Oxide in the Topcoat Layer

A first coating primer of HSP-7401 was spray applied to a fiberglass composite substrate with an Omega thermocouple attached to the surface and allowed to dry at room temperature for two hours. A second coating was prepared by modifying AUE-57035 with the addition of reduced tungsten oxide by mixing 1.3 g of reduced tungsten oxide with 165.7 g of AUE-57035. This mixture was catalyzed with the addition of 34.3 g of AUE-3550, and reduced to spray viscosity with the addition of 12 g of n-butyl acetate. Then the second coating or topcoat layer was spray applied to the sample and allowed to cure at room temperature for seven days before testing.

### Example 4

### Coating System Utilizing 1.1% Reduced Tungsten Oxide in the Primer Layer

A first coating primer was prepared by mixing 2.69 g of reduced tungsten oxide, described previously above, with 168 g of HSP-7401. The mixture was catalyzed with 32 g of AUE-3550, and reduced to spray viscosity with the addition of 40 g of n-butyl acetate. The first coating was then spray applied to a fiberglass composite substrate with a thermocouple from Omega attached to the surface. The sample was allowed to dry at room temperature for two hours. The sample was topcoated with AUE-57035 by spray application and allowed to cure at room temperature for seven days before testing.

The preparations of Examples 1-4 are set forth in formulation Table 1.

TABLE 1

| | | Example | Example | Example | Example |
|---|---|---|---|---|---|
| | | 1 | 2 | 3 | 4 |
| Primer | HSP-7401 | 168 | 168 | 168 | 168 |
| Formula | Near-IR | 0 | 1.34 | 0 | 2.69 |
| | Absorber | | | | |
| | AUE-3550 | 32 | 32 | 32 | 32 |
| | SSE-86 | 40 | 40 | 40 | 40 |
| | Totals: | 240 | 241.34 | 240 | 242.69 |
| TopCoat | AUE- | 165.7 | 165.7 | 165.7 | 165.7 |
| Formula | 57035 | | | | |
| | Near-IR | 0 | 0 | 1.3 | 0 |
| | Absorber | | | | |
| | AUE-3550 | 34.3 | 34.3 | 34.3 | 34.3 |
| | SSE-86 | 12 | 12 | 12 | 12 |
| | Totals: | 212 | 212 | 213.3 | 212 |

### Example 1-4

Several experiments were conducted to determine if adding near-IR absorbers to the above described coating systems could raise the panel temperature when exposed to a near-IR source (sunlight) and thus facilitate the melting of snow and/or ice.

As set forth in Table 2 below, the results of Examples 1-4 demonstrate that the addition of a near-IR absorber to the first coating (such as a primer) increases the temperature of the coated substrate. Incorporation of 0.6% on weight of near-IR absorber in the topcoat layer (AUE-57035) is effective at raising the panel temperature 20° F. during exposure to a near-IR source but also causes a significant color change (dE of 15-17) that could be unacceptable for some applications where a specific color is desired. Incorporation of 0.6% on weight of near-IR absorber in the primer layer (HSP-7401) was ineffective at raising the panel temperature when the topcoat was sprayed at standard film builds (2.5 mils). However, this approach was effective at raising the panel temperature by 10° F. when the topcoat layer was applied at low film builds (1.0-13 mils). Color change was also acceptable with this approach.

TABLE 2

| | | Example | Example | Example | Example | Example | Example | Example |
|---|---|---|---|---|---|---|---|---|
| | | 1A | 1B | 2A | 3 | 2B | 4A | 4B |
| Primer layer Dry | | 2.0 | 2.8 | 2.0 | 2.0 | 0.9 | 1.7 | 1.7 |
| Film Thickness | | | | | | | | |
| Topcoat layer Dry | | 2.5 | 1.3 | 2.5 | 2.5 | 1.0 | 3.0 | 1.3 |
| Film Thickness | | | | | | | | |
| Temperature | initial | 83 | 80 | 83 | 74 | 81 | 81 | 80 |
| under Near | 30″ | 97 | 96 | 100 | 113 | 110 | 104 | 110 |
| IR Lamp (° F.) | 1′ | 108 | 107 | 109 | 127 | 123 | 116 | 121 |
| Run 1 | 1′ | 120 | 120 | 118 | 142 | 132 | 127 | 131 |
| @ exposure | 30″ | | | | | | | |
| time | | | | | | | | |
| Temperature | initial | 83 | 80 | 83 | 100 | 80 | 80 | 80 |
| under Near | 30″ | 100 | 98 | 97 | 136 | 108 | 102 | 106 |
| IR Lamp (° F.) | 1′ | 112 | 109 | 108 | 149 | 121 | 115 | 120 |
| Run 2 | 1′ | 124 | 122 | 117 | 162 | 132 | 125 | 131 |
| @exposure | 30″ | | | | | | | |
| time | | | | | | | | |

| | | | | | | | |
|---|---|---|---|---|---|---|---|
| dE at 45°¹ | 0 | n/a | 0.12 | 17.13 | 0.72 | 0.94 | 1.65 |

¹Measured using an X-Rite MA6811 with illuminant/observer.

These examples demonstrate that with the proper coating system, the temperature can be effectively increased with near-IR radiation which could be useful as an ice mitigation mechanism.

Whereas particular embodiments of this invention have been described above for purposes of illustration, it will be evident to those skilled in the art that numerous variations of the details of the present invention may be made without departing from the broad inventive concept of the invention. It is understood, therefore, that this invention is not limited to the particular embodiments disclosed, but it is intended to cover modifications that are within the spirit and scope of the invention, as defined by the appended claims.

What is claimed is:

1. An ice mitigation coating system comprising:
(a) a first coating; and
(b) a second coating deposited on a least a portion of the first coating; wherein at least one of the first coating or second coating comprises a near-infrared absorber.

2. The coating system of claim 1 wherein the near-IR absorber is admixed with a dispersing agent.

3. The coating system of claim 1 wherein the near-IR absorber comprises reduced tungsten oxide.

4. The coating system of claim 1 wherein the near-IR absorber has an average particle size of 10 nm to 15 micron.

5. The coating system of claim 1 wherein the near-IR absorber has an average particle size of 50 nm to 150 nm.

6. The coating system of claim 1 wherein the first coating further comprises a film-forming resin.

7. The coating system of claim 1 wherein the second coating substantially covers the first layer.

8. The coating system of claim 1 wherein the second coating contains a near-IR absorber.

9. The coating system of claim 1 wherein the second coating comprises a thickness the range of 0.1 to 20 mils.

10. The coating system of claim 1 wherein the first coating comprises a thermoplastic and/or thermosetting composition, and the second coating comprises a different thermoplastic and/or thermosetting composition.

11. The coating system of claim 1 wherein the second coating comprises no added near-IR absorber.

12. The coating system of claim 1, wherein the near-IR absorber provides a color change to the coating system, wherein the color change has a delta E that is not greater than 5.

13. The coating system of claim 11, wherein the near-IR absorber provides a color change to the coating system, wherein the color change has a delta E that is not greater than 5.

14. A substrate comprising a multilayer coating system of claim 1 applied to a portion thereof.

15. The substrate of claim 14, wherein the substrate comprises a wind blade.

16. A method of mitigating ice build-up on a substrate, comprising applying to the substrate a film-forming composition; comprising:
(a) applying a first coating over at least a portion of the substrate; and
(b) applying a second coating over at least a portion of the first coating; wherein at least one of the first coating or second coating comprises a near-infrared absorber.

17. The method of claim 16 further including the step of curing the first coating prior to applying the second coating.

18. A substrate treated by the method of claim 16.

19. The method of claim 16 wherein the substrate comprises a carbon fiber and/or fiberglass composite substrate.
